(19) United States
(12) Patent Application Publication
(10) Pub. No.: US 2003/0084032 A1
(43) Pub. Date: May 1, 2003

(54) Methods and systems for performing a controlled search

(76) Inventors: Sukhminder Grewal, New Haven, CT (US); Mir Faiz Mohammad, Hamden, CT (US)

Correspondence Address: John S. Beulick, Armstrong Teasdale LLP, Suite 2600, One Metropolitan Sq., St. Louis, MO, 63102, US

(21) Appl. No.: 10/021,474

(22) Filed: Oct. 30, 2001

(51) Int. Cl. G06F 7/00

(52) U.S. Cl. 707/3

(57) ABSTRACT

Methods and systems for displaying search results are described. In an example embodiment, the method comprises the steps of displaying at least a portion of the search results, and displaying at least a portion of a subset of the search results based on a user selection.

### BACKGROUND OF THE INVENTION

This invention relates generally to computer network-based systems and more particularly to performing searches in such computer network-based systems.

Searching a computer network-based system to identify relevant information or individuals having expertise on a specific subject can be tedious and time consuming, especially in systems having numerous databases storing vast amounts of information such as the wide area network commonly referred to as the Internet. Even performing such searches on networks and systems that are internal to a particular company can be time consuming, inefficient, and result in identifying much information that is not relevant to the specific subject.

For example, performing a search on the Internet using commonly available search engines often results in identifying numerous information sources that are not particularly relevant to the specific subject. An operator typically at least scans the search results and attempts to view only that information that appears relevant based on the search result summaries. Even a highly experienced operator, however, may have difficulty in locating only the relevant information based on the search result summaries. In addition, the search results are highly dependent on the skill of the operator in selecting key words to be searched and in selecting a particular search engine for the search.

### BRIEF DESCRIPTION OF THE INVENTION

In one aspect, a method for displaying search results is provided. In an example embodiment, the method comprises the steps of displaying at least a portion of the search results, and displaying at least a portion of a subset of the search results based on a user selection.

In another aspect, a computer comprising a display, a user interface, and a processor programmed to cause to be displayed on the display at least a portion of the search results is provided. The processor is further programmed to cause to be displayed on the display at least a portion of a subset of the search results based on a user selection made using the user interface.

In yet another aspect, a memory having search results stored therein is provided. The search results comprise a plurality of search result category types. A first category type corresponds to a first community and a second category type corresponds to a second community.

### BRIEF DESCRIPTION OF THE DRAWINGS

FIG. 1 is a system block diagram;

FIG. 2 is a block diagram of a server system;

FIG. 3 illustrates a database configuration;

FIG. 4 is an example web page displaying search results at a network level;

FIG. 5 is an example web page displaying search results at a business level;

FIG. 6 is an example web page displaying search results at a sub-business level; and

FIG. 7 is an example web page displaying search results at a user selected “communities only” level.

### DETAILED DESCRIPTION OF THE INVENTION

Methods and systems for searching are described herein in the context of searching a network, e.g., a wide area network, a local area network. The methods and systems, however, are not limited to searching on networks and can be utilized for searching in many other contexts. For example, the methods and systems can be utilized in searching databases directly linked to a computer without requiring network access. Although the methods and systems are believed to be particularly useful in searching large databases accessible via wide area networks, such systems and methods can be used in searching many other types of data storage units.

Also, the search methods and systems are described herein as being implemented in connection with a web site accessible via a wide area network. The example web site is a single entry point through which individuals can seek support, training and action. The web site provides an integrated approach to providing internal users or customers with education, information and computer assisted or human help on a specific subject, problem or a project.

Although the web site is described herein, the search methods and systems are not limited to practice in connection with a web site nor a particular web site. Rather, such methods and systems can be implemented and practiced in connection with many other types of architectures.

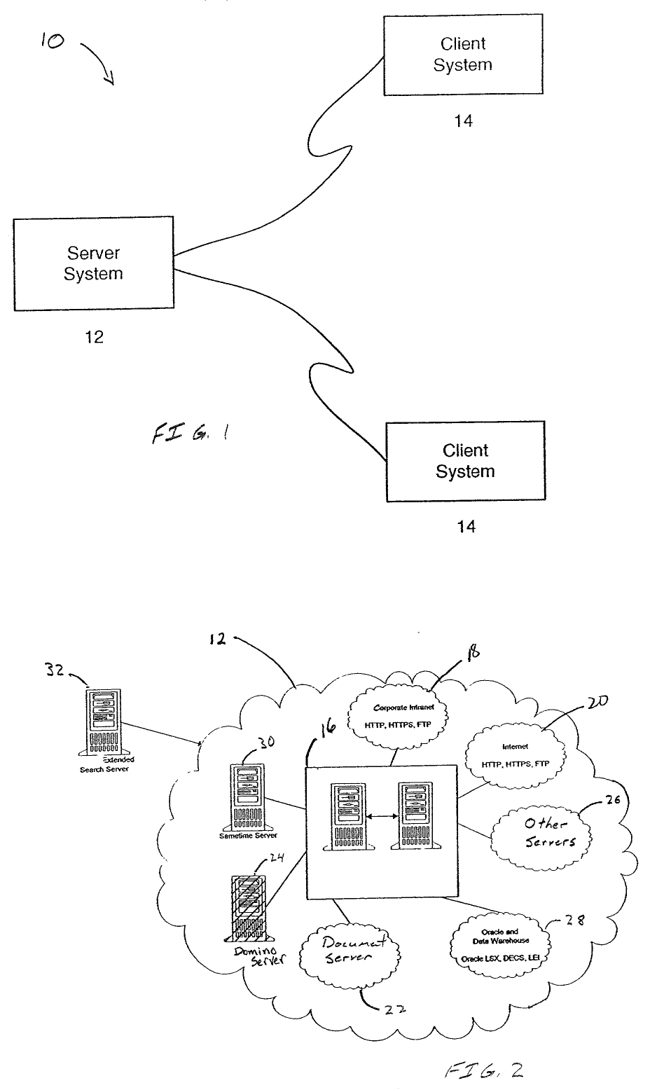

Referring now specifically to the drawings, FIG. 1 is a block diagram of a system 10 that includes a server system 12 and a plurality of client systems 14 connected to server system 12. In one embodiment, a client system 14 is a computer including a web browser. The computer further includes a processor, a display, and user interface devices, such as a keyboard, a mouse, and a touch screen.

In the example embodiment, server system 12 is accessible to client system 14 via a wide area network such as the Internet. Client system 14 is interconnected to the Internet through one of many interfaces that can be selected, including dial-in-connections, cable modems, special high-speed ISDN lines and networks such as local area networks (LANs) or wide area networks (WANs). Although client system 14 sometimes is described herein as being a computer, client system 14 could be any processor or electronic based system capable of interconnecting to the Internet including a web-based phone or other web-based connectable equipment. Servers storing information are integrated with server system 12 and can be accessed by potential users at one of client systems 14 by logging onto server system 12.

FIG. 2 is a block diagram of an example server system 12. System 12 comprises a plurality of clustered servers 16. Clustered servers 16 are configured using an Internet cluster manager and are linked to a corporate Intranet 18, the Internet 20, a document server 22, a domino server 24 and other types of servers 26. In addition, server cluster 16 is linked to databases 28 such as Oracle LSX, LEI and DECS databases. In addition, Instant Messaging, Chat Room and Webinar services are accessible through clustered servers 16 by a linked Sametime or other chat server 30. Server system 12 also includes an extended search server 32 for performing an extended search to index content linked to clustered servers 16. The databases which comprise and are accessible via system 12 are data sources which a user can search via one of client systems 14.

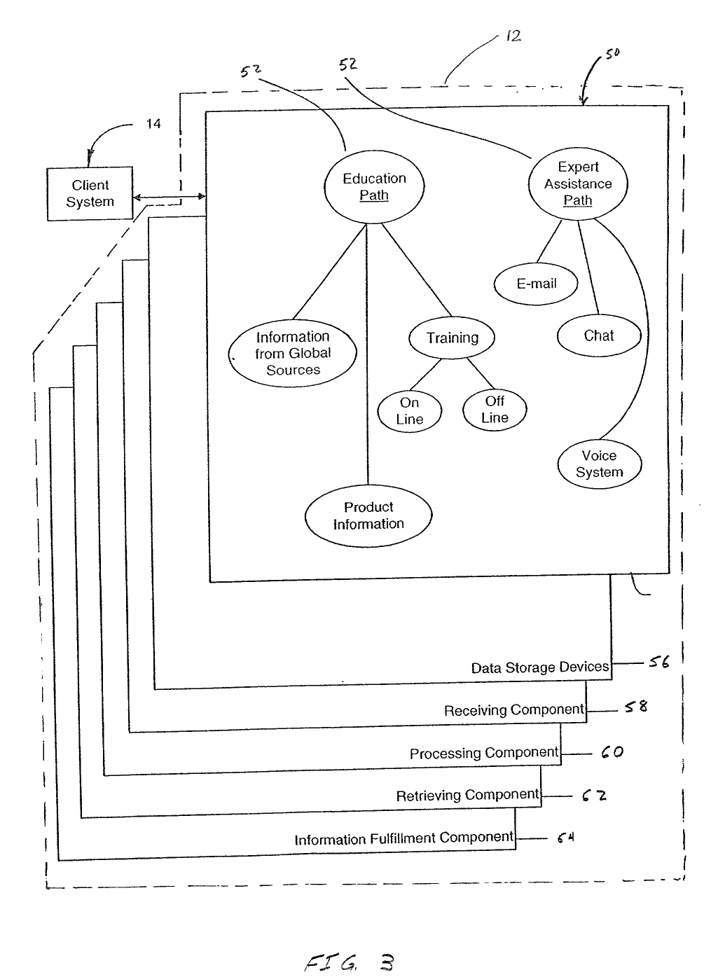

FIG. 3 illustrates a database configuration within server system 12. Database 50 includes two separate components which perform specific tasks. One database component is referred to as an Education Path Component 52 and the other database component is referred to as an Expert Assistance Path Component 54. Components 52 and 54 are further organized into data storage devices 56, a receiving component 58 for receiving request from client system 14, a processing component 60 for searching and processing received request against data storage device 56 containing a variety of help related information, a retrieving component 62 to retrieve information from the data storage device, and an information fulfillment component 64 that downloads the requested information after retrieving from the data storage device to a plurality of users in the order in which the requests were received by the receiving component.

Server system 12 is accessed, for example, through a home page which provides the user with the ability to navigate and search information. The system allows a user to navigate, search, and in some cases create/edit/delete online documentation, manuals (also available in downloadable format), frequently asked questions, articles and URLs, various pages and other discussion materials. When a first time user enters the site, the user is presented with a generic page (not shown). After the user registers in the system, a cookie is set up on the user's computer, which allows the system to customize the page on next return. Each home page also consists of several pre-set frames (not shown).

The web site described above is organized around communities targeted to specific populations of users. Users customize the web page using three vectors. Specifically, a user enters organization, function and location (geographic) information, and based on that information, communities are identified to which such user can belong. For example, a user can be a engineer in a power systems business and located in Florida. That specific user therefore could be a member of an engineering community (vector 1), an engineering community comprising engineers in power systems businesses (vector 2), as well as an engineering community comprising engineers in power systems businesses located in Florida (vector 3). The user also can customize the home page by selecting particular communities to which the user desires to belong, and can further customize the home page by selecting particular communities of interest to the user which might not relate to the user's organization, function, and location information.

The search results are displayed to the user at one of client systems 14, for example. The client system processor is programmed to display search results based on a user selection. Specifically, the vectors are used by the processor to identify search results from databases corresponding to particular communities. Therefore, the user can attempt to narrow the search results to be displayed, sometimes referred to herein as a “zoom” search.

More particularly, each search result includes a community identifier, and the processor is programmed to cause to be displayed only the search results corresponding to communities (i.e., vectors) selected by the user via the user interface. In the example, the operator can select from four different types of search results to view. A first type of search result that can be viewed includes all search results, i.e., the search results for all databases searched on the system. A second type of search result has vector 1 type results, i.e., the search results for the vector 1 type databases. A third type of search result has vector 2 type results, i.e., the search results for the vector 2 type databases. A fourth type of search result has vector 3 type results, i.e., the search results for the vector 3 type databases. The search results are along a continuum from broad to narrow, with the first type of being a most broad result and the fourth type of search result being a most narrow result.

An operator can select which type of search result should be displayed by simply making a selection on the user interface, e.g., via a web page. By allowing an operator to “zoom” in on the search results, e.g., move from viewing the very broad search result to the very narrow search result, the operator may more quickly find the specific information being sought. As used herein, the term zoom refers to narrowing search results from a more broad search result to a more narrow search result.

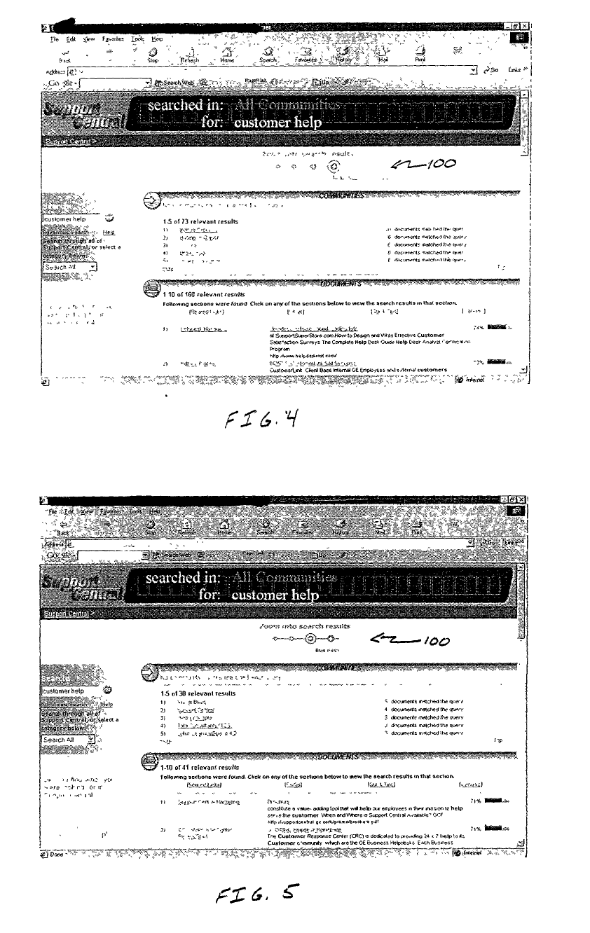

Of course, there are many different ways in which to implement the zoom search capability. One example implementation is described below in connection with FIGS. 4, 5, 6, and 7, which illustrate example pages/screen shots based on an operator selection of the type of results to be viewed. The example pages illustrated in FIGS. 4, 5, 6, and 7 are generated based on the system and databases described above in FIGS. 1, 2, and 3. Therefore, the zoom function is based on moving from a broadly defined community to a more narrowly defined, customized community. As explained above, the zoom function can be practiced in connection with many different types of architectures rather than a community based architecture.

In an exemplary embodiment, the vectors can be organized based on a commonality between the vectors. For example, certain information assigned to an aircraft engines community might also relate to a power generation community. Moreover, it is more likely that certain information assigned to an aircraft engines community might also relate to a power generation community and not to a credit card services community. Thus, the zoom function can also be employed on retrieved search results that include closely related communities. The zoom function can narrow the retrieved search results that include closely related communities and can expand the retrieved search results to include those communities that are not so closely related.

In another embodiment, the zoom function can also be employed to narrow or expand retrieved search results for a selected location. For example, after an operator has retrieved search results for a selected community and a selected location, the operator can employ the zoom function to expand the search results to include all locations and can narrow the search results by selecting a location that includes at least one of country of operator, state of operator, city of operator, and address of the operator.

The search results are stored in a memory which is a component of client system 14. Alternatively, the memory may be a component of server system 14 or even external to system 10. Each search result is associated with a vector when stored in the memory. That is, each search result includes an identifier that is used by the processor to determine a vector to which the result corresponds.

Referring now to FIG. 4, the web page includes a user interactive selection bar on which a user can select the search results to be displayed. FIG. 4 illustrates a first type of search result in which the search results for an entire system database (in this case, the SupportCentral database) are displayed for viewing by a user.

To narrow the search results to be displayed, and referring now to FIG. 5, the user simply selects a next type of search result on the selection bar. Of course, the user need not select any one of the possible types of search results in any order. For example, rather than viewing the search results sequentially from most broad to most narrow, an operator can select to view the most narrow search results immediately after viewing the most broad search results.

As shown in FIG. 5, the user has selected to view the type 2 (vector 1) results, which are the search results based on the searching conducted in the databases that comprise the user's business community. In comparing the example search results in FIG. 4 to the search results in FIG. 5, 73 relevant communities and 160 relevant documents were identified in the type 1 results and 30 relevant communities and 41 relevant documents were identified in the type 2 results. This means that more relevant results were found in searching the entire system whereas fewer relevant results were identified in searching the databases for the user's business community. However, in actuality, the type 2 search results may be the most relevant search results of the type 1 results, i.e., the type 2 search results are a subset of the type 1 search results.

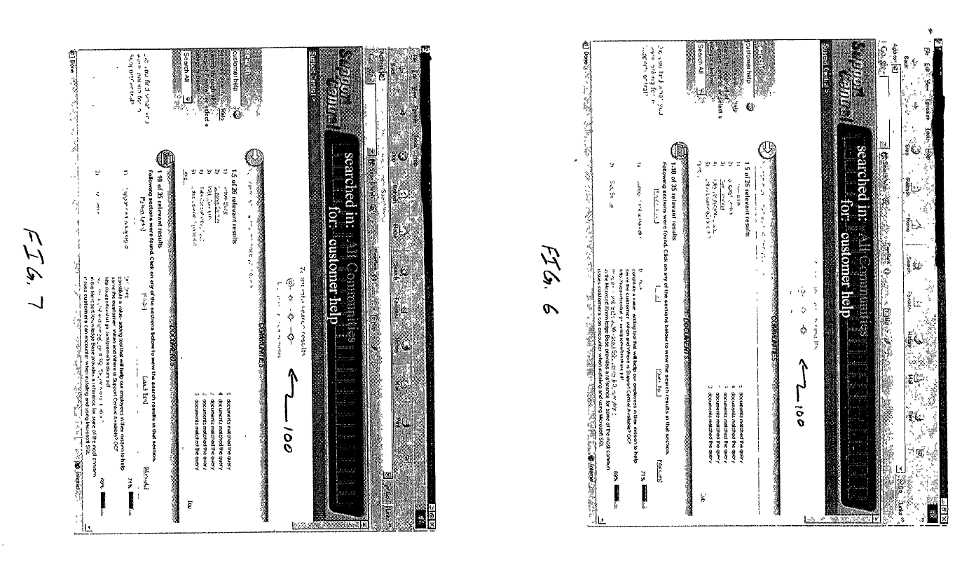

FIG. 6 illustrates a further narrowing of the search results to be displayed from vector 1 to vector 2. Specifically, the search results obtained by searching the databases of the sub-business are displayed on the page illustrated in FIG. 6.

In comparing the example search results in FIG. 5 to the search results in FIG. 6, 30 relevant communities and 41 relevant documents were identified in the type 2 results and 26 relevant communities and 35 relevant documents were identified in the type 3 results. This means that more relevant results were found in searching the business databases whereas fewer relevant results were identified in searching the databases for the user's sub-business. In actuality, the type 3 search results may be the most relevant search results of the type 2 results, i.e., the type 3 search results are a subset of the type 2 search results.

FIG. 7 illustrates an even further narrowing of the search results to the users customized communities. As explained above, these are the user selected communities in which the user may have a particular interest. The search results obtained by searching the databases of the customized communities are displayed on the page illustrated in FIG. 7.

In comparing the example search results in FIG. 6 to the search results in FIG. 7, 26 relevant communities and 35 relevant documents were identified in the type 3 results and 26 relevant communities and 35 relevant documents were identified in the type 4 results. This means that the same results were found in searching the sub-business databases as were identified in searching the databases for the user's customized communities. That is, the databases that are in the customized communities but not in the sub-business community did not have any relevant results.

The above described zoom function provides the advantage that a user can easily and quickly narrow or broaden the search results to be viewed without having to conduct an entirely new search. Rather, the search results for a particular community, or for the entire system, can be easily and readily displayed to a user for viewing.

While the invention has been described in terms of various specific embodiments, those skilled in the art will recognize that the invention can be practiced with modification within the spirit and scope of the claims.

What is claimed is:

1. A method for displaying search results, said method comprising the steps of:
displaying at least a portion of the search results; and
displaying at least a portion of a subset of the search results based on a user selection.

2. A method according to claim 1 wherein the search results are based on a search of data sources in a computer network.

3. A method according to claim 1 wherein the user selection comprises one of a plurality of communities in which the user is a member.

4. A method according to claim 1 wherein a user can select one of a plurality of types of search results to be displayed, and wherein a first type of search result that can be displayed comprises a complete set of the search results, and wherein a second type of search result comprises a subset of the complete search results.

5. A method according to claim 4 wherein the second type of search result is based on a first vector.

6. A method according to claim 5 wherein a user can select a third type and a fourth type of search results, the third type of search result based on a second vector and the fourth type of search result based on a third vector.

7. A method according to claim 5 wherein the first vector is based on a community, the community comprising at least one of a business community, a sub-business community, and a customized community.

8. A computer comprising a display, a user interface, and a processor, said processor programmed to cause to be displayed on said display at least a portion of the search results, said processor further programmed to cause to be displayed on said display at least a portion of a subset of the search results based on a user selection made using said user interface.

9. A computer according to claim 8 wherein said computer is configured to be coupled to a network, and wherein the search results are based on a search of data sources in the network.

10. A computer according to claim 9 wherein the network is at least one of a local area network and a wide area network.

11. A computer according to claim 8 wherein said user interface comprises a web page.

12. A computer according to claim 11 wherein said web page comprises a user interactive selection bar.

13. A computer according to claim 8 wherein said user selection comprises one of a plurality of communities in which the user is a member.

14. A computer according to claim 8 wherein said user interface is configured so that a user can select one of a plurality of types of search results to be displayed, and wherein a first type of search result that can be displayed comprises a complete set of the search results, and wherein a second type of search result comprises a subset of the complete search results.

15. A computer according to claim 14 wherein said second type of search result is based on a first vector.

16. A computer according to claim 15 wherein a user can select a third type and a fourth type of search results, said third type of search result based on a second vector and said fourth type of search result based on a third vector.

17. A computer according to claim 15 wherein said first vector is based on a community, said community comprising at least one of a business community, a sub-business community, and a customized community.

18. A memory for storing search results, said search results comprising a plurality of search result category types, a first of said category types corresponding to a first community and a second of said category types corresponding to a second community.

19. A memory according to claim 18 wherein said second category type is a subset of said first category type.

20. A memory according to claim 18 wherein said first community comprises at least one of a business community, a sub-business community, and a customized community.
